(19) United States
(12) Patent Application Publication
(10) Pub. No.: US 2025/0102292 A1
(43) Pub. Date: Mar. 27, 2025

(54) DEVICE AND METHOD FOR MEASURING THICKNESS

(71) Applicant: ACTRO CO., LTD, Yongin-si, Gyeonggi-do (KR)

(72) Inventors: Hak Sung KIM, Seoul (KR); Dong Woon PARK, Seoul (KR); Heon Su KIM, Seoul (KR); Sang Il KIM, Seoul (KR)

(73) Assignee: ACTRO CO., LTD, Yongin-si, Gyeonggi-do (KR)

(21) Appl. No.: 18/832,213

(22) PCT Filed: Jan. 25, 2023
(86) PCT No.: PCT/KR2023/001118

§ 371 Date: Jul. 23, 2024

(30) Foreign Application Priority Data
Jan. 27, 2022 (KR) 10-2022-0012558
Aug. 26, 2022 (KR) 10-2022-0107696

(51) Int. Cl. G01B 11/06; G01N 21/3586

(52) U.S. Cl. CPC G01B 11/06; G01N 21/3586

(57) ABSTRACT

A thickness measurement device includes: a terahertz wave emitter emitting terahertz waves toward an edge of the second layer; a terahertz wave detector detecting, with reference to a reflected location of the terahertz waves, a first terahertz wave (R₁) reflected from a surface of the second layer, a second terahertz wave (R₂) reflected from an exposed surface of the first layer, and a third terahertz wave (R₃) reflected from an interface between the first layer and the second layer; and a calculator calculating an index of refraction of the second layer based on a detection time difference (Δt₁) between a detection time of the first terahertz wave (R₁) and a detection time of the second terahertz wave (R₂) and a detection time difference (Δt₂) between the detection time of the first terahertz wave (R₁) and a detection time of the third terahertz wave (R₃).

### TECHNICAL FIELD

The present invention relates to a thickness measurement apparatus and method, and more particularly to a thickness measurement apparatus and method, which can obtain reliable thickness information about a thickness measurement object in a reflection mode of terahertz waves.

### BACKGROUND ART

Currently, as densification and miniaturization technology has attracted attention with the development of state-of-the-art industries, such as the semiconductor industry or the display industry, development of non-destructive test technology is also required in the art.

In particular, in the semiconductor industry or the display industry, specimens with various thicknesses and shapes used in micro-precision components are manufactured. Since these specimens have a great influence on performance of final products, it is necessary to manufacture such specimens with uniform thicknesses. Thus, there is a need for precise measurement of the thicknesses of the specimens during manufacture of baby specimens.

On the other hand, terahertz waves have excellent permeability with respect to non-conductive materials excluding metals and are harmless to the human body with lower energy than X-rays. With these properties, terahertz waves are applicable to non-destructive test technology.

In addition, in a specimen manufacturing process, specimens may include multiple layers of thin films. For the specimens including the multiple layers of thin films, it can be difficult to measure the thickness of each layer separately during the manufacturing process. Accordingly, when the specimen is composed of multiple layers of thin films, it is necessary to measure the thickness of each of the thin films constituting the specimen without separating the specimen into individual thin films.

Typically, the index of refraction of each thin film is measured in a transmission mode. However, when the multilayer thin film is composed of a stack of metals and non-metals, light is reflected from the metals, thereby making it difficult to obtain accurate information about the index of refraction of the thin film as the basis for calculation of the film thickness in the transmission mode.

### DISCLOSURE

### Technical Problem

It is an object of present invention to provide a thickness measurement apparatus and method that can obtain reliable thickness information about a thickness measurement object in a reflection mode of terahertz waves.

It should be understood that the present invention is not limited to the above object.

### Technical Solution

One aspect of the present invention provides a thickness measurement device.

According to one embodiment, the thickness measurement device is a thickness measurement device for measuring a thickness of a second layer in a specimen including a first layer and the second layer stacked on the first layer so as to expose an edge of the first layer upwardly, the thickness measurement apparatus including: a terahertz wave emitter emitting terahertz waves toward an edge of the second layer such that the first layer and the second layer are directly irradiated with the terahertz waves at the same time by single irradiation; a terahertz wave detector detecting, with reference to a reflected location of the terahertz waves, a first terahertz wave (R₁) reflected from a surface of the second layer, a second terahertz wave (R₂) reflected from an exposed surface of the first layer, and a third terahertz wave (R₃) reflected from an interface between the first layer and the second layer; and a calculator calculating an index of refraction of the second layer based on a detection time difference (Δt₁) between a detection time of the first terahertz wave (R₁) and a detection time of the second terahertz wave (R₂) and a detection time difference (Δt₂) between the detection time of the first terahertz wave (R₁) and a detection time of the third terahertz wave (R₃), and calculating the thickness of the second layer based on the calculated index of refraction of the second layer.

According to one embodiment, the calculator may calculate the index of refraction (nₛ) of the second layer through Equation 6.

$${n}_{s} = {n}_{air} \frac{Δ {t}_{2}}{Δ {t}_{1}} \qquad [ Equation 6 ]$$

where nₐᵢᵣ is an index of refraction of air.

According to one embodiment, the detection time difference (Δt₁) between the detection time of the first terahertz wave (R₁) and the detection time of the second terahertz wave (R₂) may be defined by Equation 1, and the detection time difference (Δt₂) between the detection time of the first terahertz wave (R₁) and the detection time of the third terahertz wave (R₃) may be defined by Equation 3, wherein Equation 1 is transformed into Equation 2, Equation 3 is transformed into Equation 4, Equation 2 and Equation 3 are transformed into Equation 5, and Equation 5 is transformed into Equation 6, and wherein the calculator may calculate the thickness of the second layer through Equation 2 or Equation 4.

$$Δ {t}_{2} = \frac{2 {d}_{1} {n}_{air}}{C} \qquad [ Equation 1 ]$$

$${d}_{1} = \frac{C Δ {t}_{1}}{2 {n}_{air}} \qquad [ Equation 2 ]$$

$$Δ {t}_{2} = \frac{2 {d}_{2} {n}_{s}}{C} \qquad [ Equation 3 ]$$

$${d}_{2} = \frac{C Δ {t}_{2}}{2 {n}_{s}} \qquad [ Equation 4 ]$$

$$Δ {t}_{2} = \frac{2 ( \frac{C Δ {t}_{1}}{2 {n}_{air}} ) {n}_{s}}{C} = Δ {t}_{1} \frac{{n}_{s}}{{n}_{air}} \qquad [ Equation 5 ]$$

where C is the speed of light, and d1 and d2 are the thicknesses of the first layer and the second layer, respectively.

According to one embodiment, the terahertz wave detector may detect the terahertz waves reflected from each of M (positive integer greater than or equal to 1)×N (positive integer greater than or equal to 1) points set on the surface of the second layer and the calculator may calculate the thickness of the second layer at each point through Equation 7.

$${d}_{mn} = \frac{C Δ {t}_{mn}}{2 {n}_{s}} \qquad [ Equation 7 ]$$

According to one embodiment, when the terahertz wave emitter emits the terahertz waves at an incidence angle (θ) of greater than 0° and less than 90° toward the edge of the second layer, the calculator may calculate the thickness of the second layer through Equation 8 converted from Equation 1, Equation 9 converted from Equation 2, Equation 10 converted from Equation 3, Equation 11 converted from Equation 4, and Equation 12 converted from Equation 5.

$$Δ {t}_{1} = \frac{2 ( \frac{d}{cos θ} ) {n}_{air}}{C} \qquad [ Equation 8 ]$$

$$d = \frac{C Δ {t}_{1}}{2 {n}_{air}} \cdot cos θ \qquad [ Equation 9 ]$$

$$Δ {t}_{2} = \frac{2 ( \frac{d}{cos [ {sin}^{- 1} ( sin θ \cdot \frac{{n}_{air}}{{n}_{s}} ) ]} ) {n}_{s}}{C} \qquad [ Equation 10 ]$$

$$d = \frac{C Δ {t}_{1}}{2 {n}_{s}} \cdot cos [ {sin}^{- 1} ( sin θ \cdot \frac{{n}_{air}}{{n}_{s}} ) ] \qquad [ Equation 11 ]$$

$$Δ {t}_{2} = \frac{2 ( \frac{\frac{C Δ {t}_{1}}{2 {n}_{air}} \cdot cos θ}{cos [ {sin}^{- 1} ( sin θ \cdot \frac{{n}_{air}}{{n}_{s}} ) ]} ) {n}_{s}}{C} = \frac{Δ {t}_{1} \cdot cos θ}{cos [ {sin}^{- 1} ( sin θ \cdot \frac{{n}_{air}}{{n}_{s}} ) ]} \frac{{n}_{s}}{{n}_{air}} \qquad [ Equation 12 ]$$

According to another embodiment, the thickness measurement apparatus is a thickness measurement apparatus for measuring a thickness of a second layer in a specimen including a first layer and the second layer stacked on the first layer, the thickness measurement apparatus including: a terahertz wave emitter emitting two terahertz waves (I₁, I₂) towards the second layer at different incidence angles on the second layer; a terahertz wave detector detecting, with reference to reflected locations of the two terahertz waves (I₁, I₂), two first terahertz waves (R_{1S}, R_{2S}) reflected from a surface of the second layer and two second terahertz waves (R_{1T}, R_{2T}) reflected from an interface between the first layer and the second layer; and a calculator calculating an index of refraction of the second layer based on a detection time difference (Δt₁) between a detection time of any one first terahertz wave (R_{1S}) of the two first terahertz waves (R_{1S}, R_{2S}) reflected from the surface of the second layer and a detection time of any one second terahertz wave (R_{1T}) of the two second terahertz wave (R_{1T}, R_{2T}) reflected from the interface between the first layer and the second layer, a detection time difference (Δt₂) between a detection time of the other first terahertz wave (R_{2S}) of the two first terahertz waves (R_{1S}, R_{2S}) reflected from the surface of the second layer and a detection time of the other second terahertz wave (R_{2T}) of the two second terahertz wave (R_{1T}, R_{2T}) reflected from the interface between the first layer and the second layer, and the incidence angles (θ₁, θ₂) of the two terahertz waves (I₁, I₂), and calculating the thickness of the second layer based on the calculated index of refraction of the second layer.

According to another embodiment, the calculator may calculate the index of refraction (nₛ) of the second layer through Equation 17.

$$\begin{matrix}{n}_{s} = \frac{\sqrt{Δ {{t}_{2}}^{2} {{n}_{air}}^{2} {sin}^{2} ( {θ}_{2} ) - Δ {{t}_{1}}^{2} {{n}_{air}}^{2} {sin}^{3} ( {θ}_{1} )}}{\sqrt{Δ {t}_{2}^{2} - Δ {{t}_{1}}^{2}}} \\ {d}_{1} = \frac{C Δ {t}_{1}}{2 {n}_{s}} \times cos ( {sin}^{- 1} ( \frac{{n}_{air} sin {θ}_{1}}{{n}_{s}} ) ) \\ {d}_{2} = \frac{C Δ {t}_{2}}{2 {n}_{s}} \times cos ( {sin}^{- 1} ( \frac{{n}_{air} sin {θ}_{2}}{{n}_{s}} ) )\end{matrix} \qquad [ Equation 17 ]$$

where nₐᵢᵣ is an index of refraction of air, C is the speed of light, and θ₁ is an incidence angle of one terahertz wave (I₁) of the two terahertz waves (I₁, I₂) on the second layer, θ₂ is an incidence angle of the other terahertz wave (I₂) of the two terahertz waves (I₁, I₂) on the second layer, and d₁ and d₂ are the thicknesses of the second layer, respectively.

According to another embodiment, Equation 17 may be derived through Equation 13 to Equation 16.

$${n}_{1} = \frac{C Δ {t}_{1}}{2 {l}_{1}} \qquad [ Equation 13 ]$$

$${n}_{2} = \frac{C Δ {t}_{2}}{2 {l}_{2}} \qquad [ Equation 14 ]$$

$${l}_{1} = \frac{{d}_{1}}{cos ( {sin}^{- 1} ( \frac{{n}_{air} sin {θ}_{1}}{{n}_{1}} ) )} \qquad [ Equation 15 ]$$

$${l}_{2} = \frac{{d}_{2}}{cos ( {sin}^{- 1} ( \frac{{n}_{air} sin {θ}_{2}}{{n}_{2}} ) )} \qquad [ Equation 16 ]$$

where l₁ is a distance which one terahertz wave (I₁) of the two terahertz waves (I₁, I₂) propagates within the second layer, l₂ is a distance which the other terahertz wave (I₂) of the two terahertz waves (I₁, I₂) propagates within the second layer, and n₁ and n₂ are the indexes of refraction of the second layer, respectively.

According to another embodiment, the thickness measurement apparatus is a thickness measurement device for measuring a thickness of a second layer in a specimen including a first layer and a second layer stacked on the first layer, the thickness measurement device including: a terahertz wave emitter emitting terahertz waves toward the second layer; a terahertz wave detector detecting, with reference to a reflected location of the terahertz waves, a first terahertz wave (R₁) reflected from a surface of the second layer, a second terahertz wave (R₂) reflected from an interface between the first layer and the second layer, and a third terahertz wave (R₃) reflected from the interface through internal reflection within the second layer; and a calculator calculating an index of refraction of the second layer based on a detection time difference (Δt₁) between a detection time of the first terahertz wave (R₁) and a detection time of the second terahertz wave (R₂), and signal intensities (I₁, I₂, I₃) of the first terahertz wave (R₁), the second terahertz wave (R₂), and the third terahertz wave (R₃), and calculating the thickness of the second layer based on the calculated index of refraction of the second layer.

According to another embodiment, the calculator may calculate the index of refraction (nₛ) of the second layer through Equation 32 and the thickness (d) of the second layer through Equation 33.

$${n}_{s} = \frac{1 + \sqrt{R}}{1 - \sqrt{R}} \times {n}_{air} = \frac{1 + \sqrt{\frac{{I}_{1} \times {I}_{3}}{{I}_{1} \times {I}_{3} + {( {I}_{2} )}^{2}}}}{1 - \sqrt{\frac{{I}_{1} \times {I}_{3}}{{I}_{1} \times {I}_{3} + {( {I}_{2} )}^{2}}}} \times {n}_{air} \qquad [ Equation 32 ]$$

$$d = \frac{C Δ {t}_{1}}{2 {n}_{2}} = \frac{C Δ {t}_{1} ( 1 - \sqrt{\frac{{I}_{1} \times {I}_{3}}{{I}_{1} \times {I}_{3} + {( {I}_{2} )}^{2}}} )}{2 {n}_{air} ( 1 + \sqrt{\frac{{I}_{1} \times {I}_{3}}{{I}_{1} \times {I}_{3} + {( {I}_{2} )}^{2}}} )} \qquad [ Equation 33 ]$$

According to another embodiment, when the terahertz wave emitter emits the terahertz wave at an incidence angle (θ) of greater than 0° and less than 90° toward the second layer, the calculator may calculate the thickness (d) of the second layer through Equation 37 converted from Equation 33.

$$d = \frac{C Δ {t}_{1}}{2 {n}_{s}} \cdot cos [ {sin}^{- 1} ( sin θ \cdot \frac{{n}_{air}}{{n}_{s}} ) ] \qquad [ Equation 37 ]$$

Another aspect of the present invention provides a thickness measurement method.

According to one embodiment, a thickness measurement method includes, for a specimen including a first layer and a second layer stacked on the first layer so as to expose an edge of the first layer upwardly, emitting terahertz waves towards an edge of the second layer such that the first layer and the second layer are directly irradiated with the terahertz waves at the same time by single irradiation; detecting, with reference to a reflected location of the terahertz waves, a first terahertz wave (R₁) reflected from a surface of the second layer, a second terahertz wave (R₂) reflected from an exposed surface of the first layer, and a third terahertz wave (R₃) reflected from an interface between the first layer and the second layer; and calculating an index of refraction of the second layer based on a detection time difference (Δt₁) between a detection time of the first terahertz wave (R₁) and a detection time of the second terahertz wave (R₂) and a detection time difference (Δt₂) between the detection time of the first terahertz wave (R₁) and a detection time of the third terahertz wave (R₃), followed by calculating a thickness of the second layer based on the calculated index of refraction of the second layer.

According to another embodiment, a thickness measurement method includes, for a specimen including a first layer and a second layer stacked on the first layer, emitting two terahertz waves (I₁, I₂) towards the second layer at different incidence angles on the second layer; detecting, with reference to reflected locations of the two terahertz waves (I₁, I₂), two first terahertz waves (R_{1S}, R_{2S}) reflected from a surface of the second layer and two second terahertz waves (R_{1T}, R_{2T}) reflected from an interface between the first layer and the second layer; and calculating an index of refraction of the second layer based on a detection time difference (Δt₁) between a detection time of any one first terahertz wave (R_{1S}) of the two first terahertz waves (R_{1S}, R_{2S}) reflected from the surface of the second layer and a detection time of any one second terahertz wave (R_{1T}) of the two second terahertz waves (R_{1T}, R_{2T}) reflected from the interface between the first layer and the second layer, a detection time difference (Δt₂) between a detection time of the other first terahertz wave (R_{2S}) of the two first terahertz waves (R_{1S}, R_{2S}) reflected from the surface of the second layer and a detection time of the other second terahertz wave (R_{2T}) of the two second terahertz waves (R_{1T}, R_{2T}) reflected from the interface between the first layer and the second layer, and the incidence angles (θ₁, θ₂) of the two terahertz waves (I₁, I₂), followed by calculating a thickness of the second layer based on the calculated index of refraction of the second layer.

According to a further embodiment, a thickness measurement method includes, for a specimen including a first layer and a second layer stacked on the first layer, emitting terahertz waves toward the second layer; detecting, with reference to a reflected location of the terahertz waves, a first terahertz wave (R₁) reflected from a surface of the second layer, a second terahertz wave (R₂) reflected from an interface between the first layer and the second layer, and a third terahertz wave (R₃) reflected from the interface through internal reflection within the second layer; and calculating an index of refraction of the second layer based on a detection time difference (Δt₁) between a detection time of the first terahertz wave (R₁) and a detection time of the second terahertz wave (R₂), and signal intensities (I₁, I₂, I₃) of the first terahertz wave (R₁), the second terahertz wave (R₂), and the third terahertz wave (R₃), followed by calculating a thickness of the second layer based on the calculated index of refraction of the second layer.

### Advantageous Effects

According to embodiments of the present invention, a thickness measurement device for measuring a thickness of a second layer in a specimen including a first layer and the second layer stacked on the first layer so as to expose an edge of the first layer upwardly may include a terahertz wave emitter emitting terahertz waves toward an edge of the second layer such that the first layer and the second layer are directly irradiated with the terahertz waves at the same time by single irradiation; a terahertz wave detector detecting, with reference to a reflected location of the terahertz waves, a first terahertz wave (R₁) reflected from a surface of the second layer, a second terahertz wave (R₂) reflected from an exposed surface of the first layer, and a third terahertz wave (R₃) reflected from an interface between the first layer and the second layer; and a calculator calculating an index of refraction of the second layer based on a detection time difference (Δt₁) between a detection time of the first terahertz wave (R₁) and a detection time of the second terahertz wave (R₂) and a detection time difference (Δt₂) between a detection time of the first terahertz wave (R₁) and a detection time of the third terahertz wave (R₃), and calculating the thickness of the second layer based on the calculated index of refraction of the second layer.

Accordingly, embodiments of the present invention may provide a thickness measurement apparatus and method that can obtain reliable thickness information about a thickness measurement object in a reflection mode of terahertz waves.

In other words, according to the embodiments of the present invention, the thickness measurement apparatus and method may calculate an index of refraction of a thickness measurement object based on a time parameter in which terahertz waves emitted towards and then reflected from the thickness measurement object are detected, and may calculate the thickness of the thickness measurement object based on the calculated index of refraction.

In particular, in a typical transmission mode, it is difficult to obtain accurate information about an index of refraction and thickness of a stack of metals and non-metals, whereas the thickness measurement device and method according to the embodiments of the invention can provide accurate information about the index of refraction and thickness thereof.

### DESCRIPTION OF DRAWINGS

FIG. 1 is a block diagram of a thickness measurement device according to one embodiment of the present invention.

FIG. 2 is a schematic diagram of a terahertz wave emitter of the thickness measurement device according to the embodiment of the present invention.

FIG. 3 is a schematic diagram of a terahertz wave detector of the thickness measurement device according to the embodiment of the present invention.

FIG. 4 is a graph for illustrating a calculator of the thickness measurement device according to the embodiment of the present invention.

FIG. 5 is a schematic diagram illustrating thickness measurement at each point set on a surface of a thickness measurement object through the thickness measurement device according to the embodiment of the present invention.

FIG. 6 is a mapping diagram of thickness measurement over the entire area of the thickness measurement object.

FIG. 7 and FIG. 8 are schematic diagrams illustrating thickness measurement on an object through the thickness measurement device according to the embodiment of the present invention when terahertz waves are emitted at an angle of incidence other than 90°.

FIG. 9 is a flowchart illustrating a thickness measurement method according to one embodiment of the present invention.

FIG. 10 is a block diagram of a thickness measurement device according to another embodiment of the present invention.

FIG. 11 is a schematic diagram of the thickness measurement device according to another embodiment of the present invention.

FIG. 12 is a schematic diagram of a terahertz wave emitter of the thickness measurement device according to another embodiment of the present invention.

FIG. 13 is a schematic diagram of a terahertz wave detector of the thickness measurement device according to another embodiment of the present invention.

FIG. 14 is a graph for illustrating a calculator of the thickness measurement device according to another embodiment of the present invention.

FIG. 15 is a graph for illustrating Example 2.

FIG. 16 is a flowchart illustrating a thickness measurement method according to another embodiment of the present invention.

FIG. 17 is a block diagram of a thickness measurement device according to a further embodiment of the present invention.

FIG. 18 is a schematic diagram of a terahertz wave emitter of the thickness measurement device according to a further embodiment of the present invention.

FIG. 19 is a schematic diagram of a terahertz wave detector of the thickness measurement device according to a further embodiment of the present invention.

FIG. 20 is a graph to illustrate a calculator of the thickness measurement device according to a further embodiment of the present invention.

FIG. 21 is a schematic diagram illustrating thickness measurement on a thickness measurement object through the thickness measurement device according to a further embodiment of the present invention when terahertz waves are emitted at an angle of incidence other than 90°.

FIG. 22 is a graph for illustrating Example 2.

FIG. 23 is a flowchart illustrating a thickness measurement method according to a further embodiment of the present invention.

### BEST MODE

Hereinafter, exemplary embodiments of the present invention will be described with reference to the accompanying drawings. However, it should be understood that the present invention is not limited to the following embodiments and may be embodied in different ways. In addition, it should be understood that the following embodiments are provided for complete disclosure and thorough understanding of the present invention by those skilled in the art.

It will be understood that when an element is referred to as being placed “on” another element, it can be directly placed on the other element or intervening elements may also be present. It should be noted that the drawings are not to precise scale and may be exaggerated in shape and size of components for descriptive convenience and clarity only.

Although the terms first, second, and the like may be used in various embodiments to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section. Each of embodiments described and exemplified herein include complementary embodiments thereof. As used herein, “and/or” includes any and all combinations of one or more of the associated listed items.

As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. When an element is referred to as being “connected to,” or “coupled to” another element, it may be directly connected or coupled to the other element or intervening elements may be present.

Descriptions of known functions and constructions which can unnecessarily obscure the subject matter of the present invention will be omitted.

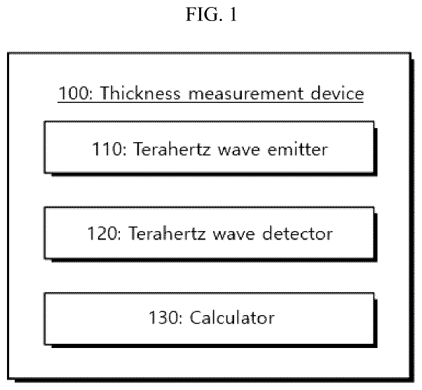

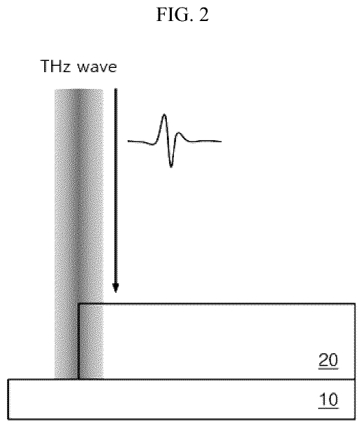

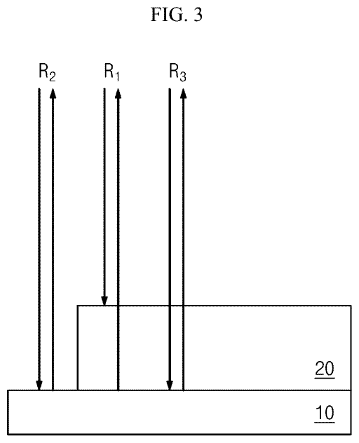

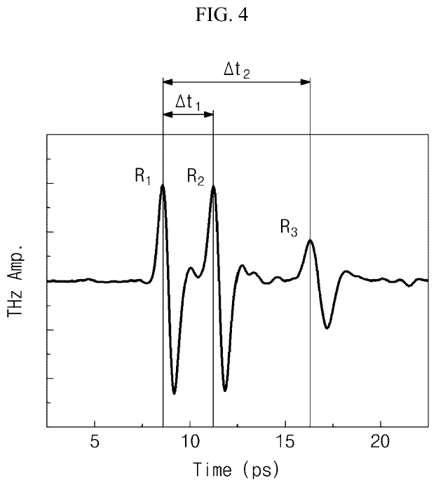

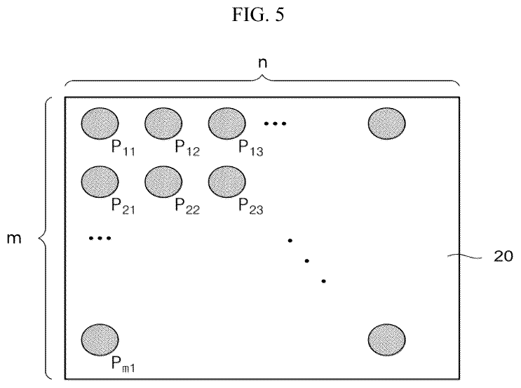

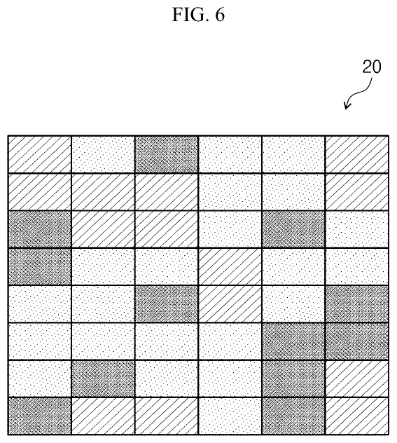

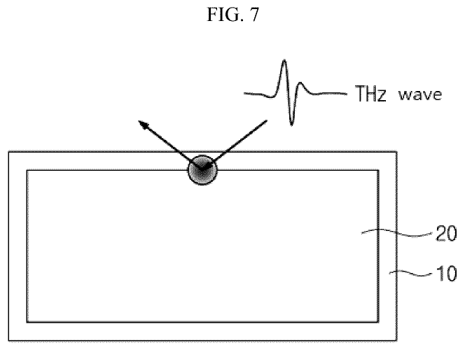

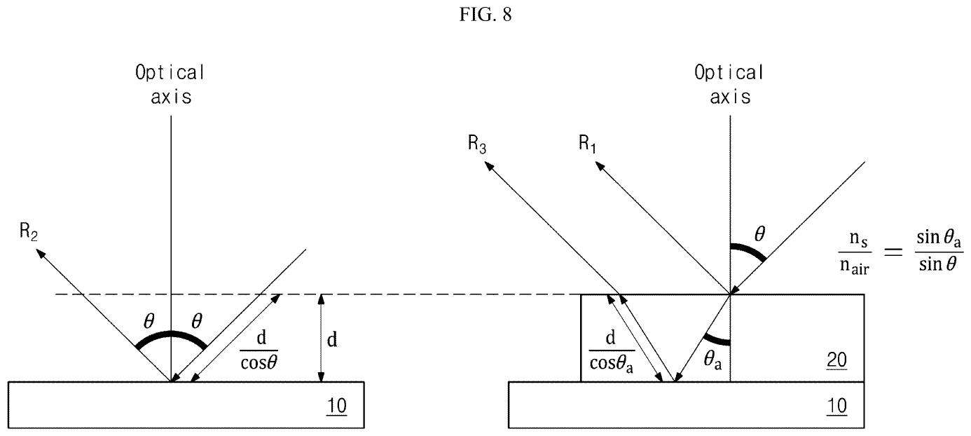

FIG. 1 is a block diagram of a thickness measurement device according to one embodiment of the invention, FIG. 2 is a schematic diagram of a terahertz wave emitter of the thickness measurement device according to the embodiment of the invention, FIG. 3 is a schematic diagram of a terahertz wave detector of the thickness measurement device according to the embodiment of the invention, FIG. 4 is a graph for illustrating a calculator of the thickness measurement device according to the embodiment of the invention, FIG. 5 is a schematic diagram illustrating thickness measurement at each point set on a surface of a thickness measurement object through the thickness measurement device according to the embodiment of the invention, FIG. 6 is a mapping diagram of thickness measurement over the entire area of the thickness measurement object, and FIG. 7 and FIG. 8 are schematic diagrams illustrating thickness measurement on an object through the thickness measurement device according to the embodiment of the invention when terahertz waves are emitted at an angle of incidence other than 90°.

Referring to FIG. 1 and FIG. 2, a thickness measurement device 100 according to one embodiment of the present invention measures a thickness of a second layer 20 as a thickness measurement object in a specimen including a first layer 10 and the second layer 20 stacked on the first layer 10 so as to expose an edge of the first layer 10 upwardly.

Here, the thickness measurement device 100 according to this embodiment measures the thickness of the second layer 20 in a reflection mode of terahertz waves (THz waves), whereby the thickness of the second layer 20 can be accurately measured even when the first layer 10 is composed of metal.

The thickness measurement device 100 according to this embodiment may include a terahertz wave emitter 110, a terahertz wave detector 120, and a calculator 130.

The terahertz wave emitter 110 emits terahertz waves towards the specimen. According to the embodiment, the terahertz wave emitter 110 may emit the terahertz waves towards an edge of the second layer 20 such that the first layer 10 and the second layer 20 placed at different heights are directly irradiated with the terahertz waves at the same time by single irradiation.

Accordingly, the terahertz waves emitted from the terahertz wave emitter 110 may be simultaneously delivered to a surface of the second layer 20, an exposed surface of the first layer 10, and an interface between the first layer 10 and the second layer 20.

Here, according to this embodiment, the terahertz wave emitter 110 may emit the terahertz waves in a direction perpendicular to the surface of the specimen.

The terahertz wave detector 120 may detect the terahertz waves that are reflected from the surfaces of the first layer 10 and the second layer 20 and from the interface therebetween after simultaneously irradiating the first layer 10 and the second layer 20. Here, since the terahertz waves may be perpendicularly delivered to the first layer 10 and the second layer 20, the terahertz waves may be perpendicularly reflected therefrom. Accordingly, the terahertz wave detector 120 may be disposed at a location to detect the perpendicularly reflected terahertz waves.

Referring to FIG. 3, the terahertz wave detector 120 may detect the terahertz waves reflected from three portions on the specimen to provide the calculator 130 with data for calculation of the thickness of the second layer 20.

Specifically, according to this embodiment, the terahertz wave detector 120 may detect a first terahertz wave (R₁) perpendicularly reflected from the surface of the second layer 20 after being perpendicularly delivered thereto through the terahertz wave emitter 110.

In addition, the terahertz wave detector 120 may detect a second terahertz wave (R₂) perpendicularly reflected from the exposed surface of the first layer 10 after being perpendicularly delivered thereto through the terahertz wave emitter 110.

Further, the terahertz wave detector 120 may detect a third terahertz wave (R₃) perpendicularly reflected from the interface between the first layer 10 and the second layer 20 after being perpendicularly delivered thereto through the terahertz wave emitter 110.

The calculator 130 may calculate an index of refraction of the specimen, more specifically the second layer 20, which is the thickness measurement object, based on a time parameter of the terahertz waves emitted towards the specimen through the terahertz wave emitter 110 and detected through the terahertz wave detector 120, and may calculate the thickness of the second layer 20 based on the calculated index of refraction.

That is, as shown in FIG. 4, according to this embodiment, the calculator 130 may calculate the index of refraction of the second layer 20 based on a detection time difference (Δt₁) between a detection time of the first terahertz wave (R₁), which is perpendicularly reflected from the surface of the second layer 20 after being perpendicularly delivered thereto through the terahertz wave emitter 110, and a detection time of the second terahertz wave (R₂), which is perpendicularly reflected from the exposed surface of the first layer 10 after being perpendicularly delivered thereto through the terahertz wave emitter 110, and a detection time difference (Δt₂) between the detection time of the first terahertz wave (R₁) and a detection time of the third terahertz wave (R₃), which is perpendicularly reflected from the interface between the first layer 10 and the second layer 20 after being perpendicularly delivered thereto through the terahertz wave emitter 110.

Here, according to this embodiment, in determining the detection times of the first terahertz wave R₁, the second terahertz wave R₂, and the third terahertz wave R₃, the calculator 130 may determine the detection times based on maximum values of the first terahertz wave R₁, the second terahertz wave R₂, and the third terahertz wave R₃, as shown in FIG. 4.

Alternatively, the calculator 130 may determine the detection times thereof based on minimum values of the first terahertz wave (R₁), the second terahertz wave (R₂), and the third terahertz wave (R₃), or may determine the detection times thereof based on intermediate values between the maximum values and the minimum values.

In addition, the calculator 130 may calculate the thickness of the second layer 20 based on the calculated index of refraction of the second layer 20.

To this end, the calculator 130 may define the detection time difference (Δt₁) between the detection time of the first terahertz wave (R₁) and the detection time of the second terahertz wave (R₂) according to Equation 1 based on the thickness of the second layer 20 and the index of refraction of air.

$$Δ {t}_{1} = \frac{2 {d}_{1} {n}_{air}}{C} \qquad [ Equation 1 ]$$

Here, the calculator 130 may transform Equation 1 into the following Equation 2.

$${d}_{1} = \frac{C Δ {t}_{1}}{2 {n}_{air}} \qquad [ Equation 2 ]$$

where d₁ is a thickness of the second layer 20, nₐᵢᵣ is the index of refraction of air, and C is the speed of light.

Further, according to the embodiment, the calculator 130 may define the detection time difference (Δt₂) between the detection time of the first terahertz wave (R₁) and the detection time of the third terahertz wave (R₃) according to Equation 3 based on the thickness of the second layer 20 and the index of refraction of air.

$$Δ {t}_{2} = \frac{2 {d}_{2} {n}_{s}}{C} \qquad [ Equation 3 ]$$

Here, the calculator 130 may transform Equation 3 into the following Equation 4.

$${d}_{2} = \frac{C Δ {t}_{2}}{2 {n}_{s}} \qquad [ Equation 4 ]$$

where d₂ is a thickness of the second layer 20, C is the speed of light, and nₛ is the index of refraction of the second layer 20.

Next, since d₁ and d₂ equally denote the thickness of the second layer 20, the calculator 130 may substitute Equation 2 into Equation 3, which may be transformed into the following Equation 5.

$$Δ {t}_{2} = \frac{2 ( \frac{C Δ {t}_{1}}{2 {n}_{air}} ) {n}_{s}}{C} = Δ {t}_{1} \frac{{n}_{s}}{{n}_{air}} \qquad [ Equation 5 ]$$

In addition, the calculator 130 may transform Equation 5 into the following Equation 6 for the index of refraction (nₛ) of the second layer 20.

$${n}_{s} = {n}_{air} \frac{Δ {t}_{2}}{Δ {t}_{1}} \qquad [ Equation 6 ]$$

According to this embodiment, the calculator 130 may calculate the index of refraction (nₛ) of the second layer 20 through Equation 6.

As confirmed in Equation 6, the index of refraction (nₛ) of the second layer 20 may be calculated from the time parameters, that is, the detection time difference (Δt₁) between the detection time of the first terahertz wave (R₁) and the detection time of the second terahertz wave (R₂) and the detection time difference (Δt₂) between the detection time of the first terahertz wave (R₁) and the detection time of the third terahertz wave (R₃).

Here, according to this embodiment, the calculator 130 may calculate the thickness of the second layer 20 through Equation 2 or by applying the index of refraction (n) of the second layer 20 calculated through Equation 6 to Equation 4.

On the other hand, the thickness measurement device 100 according to the embodiment of the invention may measure the thickness of the second layer 20 over the entire area of the second layer 20.

To this end, referring to FIG. 5, M (positive integers greater than or equal to 1)×N (positive integers greater than or equal to 1) points may be set on the surface of the second layer 20.

According to the embodiment, the terahertz wave detector 120 may detect the terahertz waves reflected from each of a plurality of points set on the surface of the second layer 20.

Accordingly, the calculator 130 may calculate the thickness of the second layer 20 at each point based on the index of refraction (nₛ) of the second layer 20 calculated through Equation 6 and Equation 7.

$${d}_{mn} = \frac{C Δ {t}_{mn}}{2 {n}_{s}} \qquad [ Equation 7 ]$$

where dₘₙ is the thickness of the second layer 20 at point Pₘₙ and Δtₘₙ is a detection time difference between the detection time of the first terahertz wave R₁, which is reflected from the surface of the second layer 20 at point Pₘₙ after being emitted thereto, and the detection time of the third terahertz wave R₃, which is reflected from the interface between the first layer 10 and the second layer 20 at point Pₘₙ after being emitted thereto.

Here, mn may define the coordinates of a point on the surface of the second layer 20. For example, point P₂₃ may mean the coordinates of an intersection point between a second column in a longitudinal direction and a third column in a transverse direction.

As shown in FIG. 6, the calculator 130 may map information about the calculated thickness of the second layer 20 at each point to display the information.

On the other hand, as shown in FIG. 7 and FIG. 8, according to the embodiment, the terahertz waves may be emitted at an incidence angle θ of greater than 0° and less than 90° towards an edge of the second layer 20 through the terahertz wave emitter 110 and may be reflected at an angle symmetrical to the incidence angle θ to be detected by the terahertz wave detector 120.

Accordingly, the calculator 130 may incorporate the incidence angle θ into the above equations.

That is, according to the embodiment, the calculator 130 may convert Equation 1 into the following Equation 8 by incorporating the incidence angle θ of the terahertz waves into Equation 1.

$$Δ {t}_{1} = \frac{2 ( \frac{d}{cos θ} ) {n}_{air}}{C} \qquad [ Equation 8 ]$$

Here, the calculator 130 may transform Equation 8 into the following Equation 9.

$$d = \frac{C Δ {t}_{1}}{2 {n}_{air}} \cdot cos θ \qquad [ Equation 9 ]$$

Equation 9 is a conversion formula that incorporates the incidence angle (θ) of the terahertz waves to Equation 2.

Further, the calculator 130 may convert Equation 3 into Equation 10 by incorporating the incidence angle θ of the terahertz waves into Equation 3.

$$Δ {t}_{2} = \frac{2 ( \frac{d}{cos [ {sin}^{- 1} ( sin θ \cdot \frac{{n}_{air}}{{n}_{s}} ) ]} ) {n}_{s}}{C} \qquad [ Equation 10 ]$$

Here, the calculator 130 may transform Equation 10 into the following Equation 11.

$$d = \frac{C Δ {t}_{2}}{2 {n}_{s}} \cdot cos [ {sin}^{- 1} ( sin θ \cdot \frac{{n}_{air}}{{n}_{s}} ) ] \qquad [ Equation 11 ]$$

Equation 11 is a conversion formula that incorporates the incidence angle (θ) of the terahertz wave to Equation 4.

Next, the calculator 130 may substitute Equation 9 into Equation 10, which may be transformed into the following Equation 12.

$$[ Equation 12 ]$$

$$Δ {t}_{2} = \frac{2 ( \frac{\frac{C Δ {t}_{1}}{2 {n}_{air}} \cdot cos θ}{cos [ {sin}^{- 1} ( sin θ \frac{{n}_{air}}{{n}_{s}} ) ]} ) {n}_{s}}{C} = \frac{Δ {t}_{1} \cdot cos θ}{cos [ {sin}^{- 1} ( sin θ \frac{{n}_{air}}{{n}_{s}} ) ]} \frac{{n}_{s}}{{n}_{air}}$$

According to this embodiment, the calculator 130 may calculate the index of refraction (nₛ) of the second layer 20 through Equation 12 when the terahertz waves are not perpendicularly emitted towards the specimen, that is, when the terahertz waves are emitted towards the specimen at an incidence angle (θ) of greater than 0° and less than 90°.

Further, the calculator 130 may calculate the thickness of the second layer 20 through Equation 9 or by incorporating the index of refraction (n) of the second layer 10 calculated through Equation 12 into Equation 11.

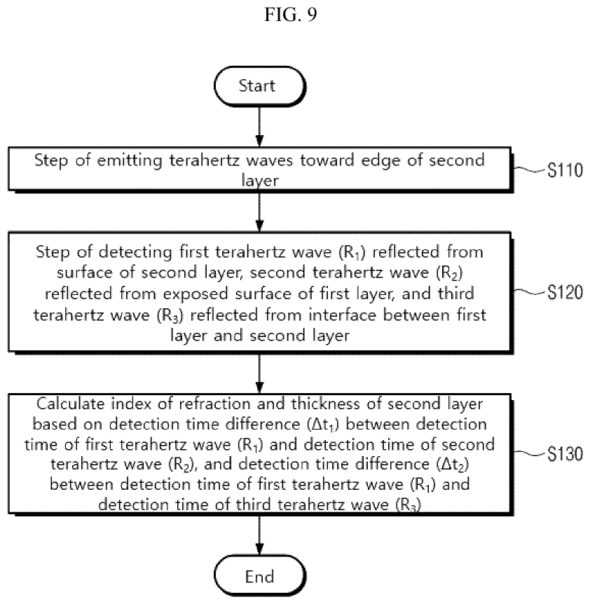

Hereinafter, a thickness measurement method according to one embodiment of the present invention will be described with reference to FIG. 9.

FIG. 9 is a flowchart illustrating a thickness measurement method according to one embodiment of the present invention.

Referring to FIG. 9, the thickness measurement method according to this embodiment may include Steps S110 to S130.

### Step S110

In Step S110, for a specimen including a first layer 10 and a second layer 20 stacked on the first layer 10 so as to expose an edge of the first layer 10 upwardly, terahertz waves may be emitted toward the edge of the second layer 20.

In Step S110, the terahertz waves may be emitted toward the edge of the second layer 20 such that the first layer 10 and the second layer 20 placed at different heights are directly irradiated with the terahertz waves at the same time by single irradiation.

Accordingly, the terahertz waves may be simultaneously delivered to a surface of the second layer 20, an exposed surface of the first layer 10, and an interface between the first layer 10 and the second layer 20.

### Step S120

In Step S120, the terahertz waves reflected from the surfaces of the first layer 10 and the second layer 20 or from the interface therebetween after being simultaneously delivered thereto may be detected.

Specifically, in Step S120, a first terahertz wave (R₁) reflected from the surface of the second layer 20 after being emitted thereto may be detected. In addition, in Step S120, a second terahertz wave (R₂) reflected from the exposed surface of the first layer 10 after being emitted thereto may be detected. Further, in Step S120, a third terahertz wave (R₃) reflected from the interface between the first layer 10 and the second layer 20 after being emitted thereto may be detected.

### Step S130

In Step S130, an index of refraction of the second layer 20 may be calculated based on a detection time difference (Δt₁) between a detection time of the first terahertz wave (R₁), which is reflected from the surface of the second layer 20 after being emitted thereto, and a detection time of the second terahertz wave (R₂), which is reflected from the exposed surface of the first layer 10 after being perpendicularly emitted thereto, and a detection time difference (Δt₂) between the detection time of the first terahertz wave (R₁) and a detection time of the third terahertz wave (R₃), which is reflected from the interface between the first layer 10 and the second layer 20 after being emitted thereto.

Here, in Step S130, the detection times may be determined based on maximum values of the first terahertz wave (R₁), the second terahertz wave (R₂), and the third terahertz wave (R₃).

Alternatively, in Step S130, the detection times may be determined based on minimum values of the first terahertz wave (R₁), the second terahertz wave (R₂), and the third terahertz wave (R₃), or based on intermediate values between the maximum values and the minimum values.

Then, in Step S130, the thickness (d) of the second layer 20 may be calculated based on the calculated index of refraction (nₛ) of the second layer 20.

According to this embodiment, in Step S130, when the terahertz waves are perpendicularly emitted towards the specimen, more specifically towards the edge of the second layer 20, the index of refraction (nₛ) of the second layer 20 may be calculated through Equation 6, and the calculated index of refraction (nₛ) of the second layer 20 may be applied to Equation 4 to calculate the thickness (d) of the second layer 20.

Further, in Step S130, when the terahertz waves are emitted at an incidence angle (θ) of greater than 0° and less than 90° toward the specimen, more specifically toward the edge of the second layer 20, the index of refraction (nₛ) of the second layer 20 may be calculated through Equation 12, and the calculated index of refraction (nₛ) of the second layer 20 may be applied to Equation 11 to calculate the thickness (d) of the second layer 20.

In Step S130, when M (a positive integer of at least 1)×N (a positive integer of at least 1) points are set on the surface of the second layer 20 in the form of a grid, the thickness of the second layer 20 at each of the plurality of points set may be calculated through Equation 6 and Equation 7.

As such, in Step S130, information about a thickness deviation of the second layer 20 may be provided by measuring the thickness of the second layer 20 at each point over the entire area of the second layer 20, that is, over the entire surface of the second layer 20.

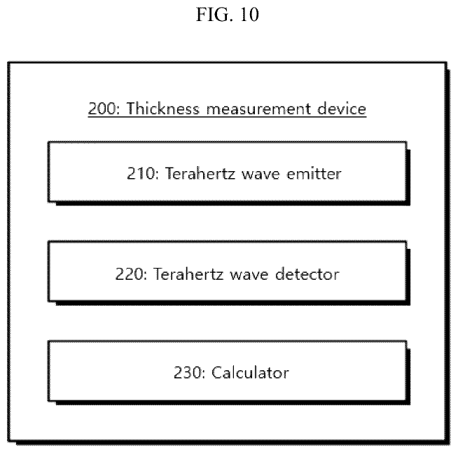

Hereinafter, a thickness measurement device according to another embodiment of the invention will be described with reference to FIG. 10 to FIG. 14.

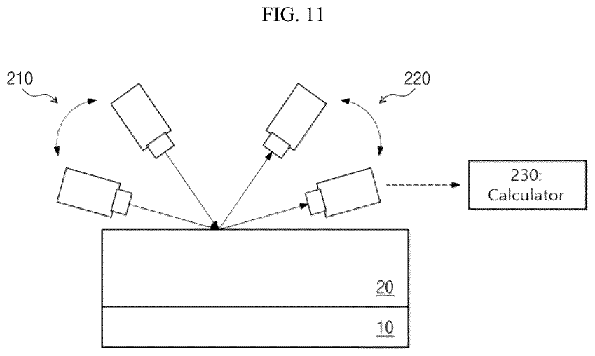

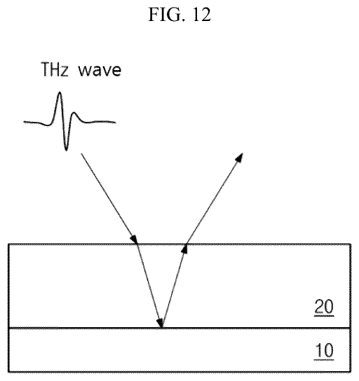

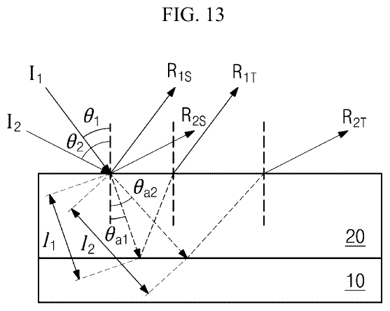

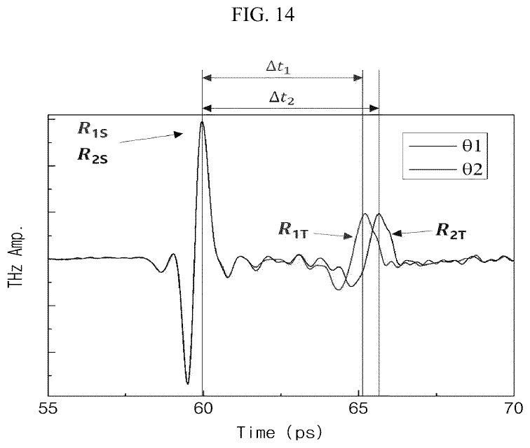

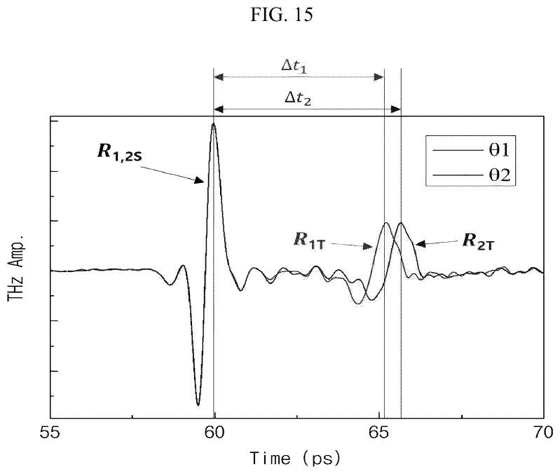

FIG. 10 is a block diagram of a thickness measurement device according to another embodiment of the invention, FIG. 11 is a schematic diagram of the thickness measurement device according to another embodiment of the invention, FIG. 12 is a schematic diagram of a terahertz wave emitter of the thickness measurement device according to another embodiment of the invention, FIG. 13 is a schematic diagram of a terahertz wave detector of the thickness measurement device according to another embodiment of the invention, FIG. 14 is a graph for illustrating a calculator of the thickness measurement device according to another embodiment of the invention, and FIG. 15 is a graph for illustrating Example 2.

Referring to FIG. 10 to FIG. 13, the thickness measurement device 200 according to another embodiment of the invention is a device for measuring the thickness of the second layer 20, which is a thickness measurement object, in a specimen including a first layer 10 and a second layer 20 stacked on the first layer 10. Here, like the thickness measurement apparatus 100 of FIG. 1, the thickness measurement apparatus 200 according to this embodiment measures the thickness of the second layer 20 in a reflection mode of terahertz waves (THz waves), whereby the thickness of the second layer 20 can be accurately measured even when the first layer 10 is composed of metal.

The thickness measurement device 200 according to this embodiment may include a terahertz wave emitter 210, a terahertz wave detector 220, and a calculator 230.

The terahertz wave emitter 210 may emit two terahertz waves (I₁, I₂) towards the second layer 20 at different incidence angles on the second layer 20.

Here, as shown in FIG. 11, the terahertz wave emitter 210 may be provided with two terahertz wave emitting devices to emit the two terahertz waves (I₁, I₂) at different incidence angles. However, it should be understood that this structure is provided by way of example only and the terahertz wave emitter 210 may include a single terahertz wave emitting device. Accordingly, the single terahertz wave emitting device may emit terahertz waves twice while moving.

The terahertz wave detector 220 may detect two first terahertz waves (R_{1S}, R_{2S}) reflected from the surface of the second layer 20 with reference to reflected locations of the two terahertz waves (I₁, I₂).

In addition, the terahertz wave detector 220 may detect two second terahertz waves (R_{1T}, R_{2T}) reflected from an interface between the first layer 10 and the second layer 20.

When the terahertz wave emitter 210 is provided with two terahertz wave emitting devices, the terahertz wave detector 220 may also be provided with two terahertz wave detection devices corresponding thereto. In addition, in an embodiment wherein the terahertz wave detector is realized by a single terahertz wave emitting device adapted to emit two terahertz waves (I₁, I₂) at different incidence angles while moving, the terahertz wave detector 220 may be realized by the single terahertz wave detection device to detect the four reflected terahertz waves (R_{1S}, R_{2S}. R_{1T}, R_{2T}) while moving.

Referring to FIG. 14, the calculator 230 may calculate an index of refraction of the second layer 20 based on a detection time difference (Δt₁) between a detection time of any one first terahertz wave (R_{1S}) of the two first terahertz waves (R_{1S}, R_{2S}) reflected from the surface of the second layer 20 and a detection time of any one second terahertz wave (R_{1T}) of the two second terahertz wave (R_{1T}, R_{2T}) reflected from the interface between the first layer 10 and the second layer 20, a detection time difference (Δt₂) between a detection time of the other first terahertz wave (R_{2S}) of the two first terahertz waves (R_{1S}, R_{2S}) reflected from the surface of the second layer 20 and a detection time of the other second terahertz wave (R_{2T}) of the two second terahertz wave (R_{1T}, R_{2T}) reflected from the interface between the first layer 10 and the second layer 20, and the incidence angles (θ₁, θ₂) of the two terahertz waves (I₁, I₂).

Here, according to this embodiment, in determining the detection times of the first terahertz waves (R_{1S}, R_{2S}) and the second terahertz waves (R_{1T}, R_{2T}), the calculator 230 may determine the detection times based on maximum values thereof, minimum values thereof, or intermediate values between the maximum values and the minimum values.

In addition, the incidence angles (θ₁, θ₂) of the two terahertz waves (I₁, I₂) may range from 0° to 90°.

According to the embodiment, the calculator 230 may calculate the thickness of the second layer 20 based on the calculated index of refraction of the second layer 20.

To this end, for the terahertz wave (I₁), the calculator 230 may define the index of refraction (n₁) of the second layer 20 according to Equation 13 based on the speed of light (C), the detection time difference between the detection time of the first terahertz wave (R_{1S}) and the detection time of the second terahertz wave (R_{1T}) (Δt₁), and a distance (l₁) which the terahertz wave (I₁) propagates into the second layer 20.

$${n}_{1} = \frac{C Δ {t}_{1}}{2 {l}_{1}} \qquad [ Equation 13 ]$$

In addition, for the terahertz wave (I₂), the calculator 230 may define the index of refraction (n₂) of the second layer 20 according to Equation 14 based on the speed of light (C), the detection time difference (Δt₂) between the detection time of the first terahertz wave (R_{2S}) and the detection time of the second terahertz wave (R_{2T}), and a distance (l₂) which the terahertz wave (I₂) propagates into the second layer 20.

$${n}_{2} = \frac{C Δ {t}_{2}}{2 {l}_{2}} \qquad [ Equation 14 ]$$

Here, the calculator 230 may define the distance (l₁) which the terahertz wave (I₁) propagates into the second layer 20 according to Equation 15 based on the thickness (d₁) of the second layer 20, the index of refraction (n₁) of the second layer 20, the index of refraction (nₐᵢᵣ) of air, and the incidence angle (θ₁) of the emitted terahertz wave (I₁).

$${l}_{1} = \frac{{d}_{1}}{cos ( {sin}^{- 1} ( \frac{{n}_{air} sin {θ}_{1}}{{n}_{1}} ) )} \qquad [ Equation 15 ]$$

Further, the calculator 230 may define the distance (l₂) which the terahertz wave (I₂) propagates into the second layer 20 according to Equation 16 based on the thickness (d₂) of the second layer 20, the index of refraction (n₂) of the second layer 20, the index of refraction (nₐᵢᵣ) of air, and the incidence angle (θ₂) of the emitted terahertz wave (I₂).

$${l}_{2} = \frac{{d}_{2}}{cos ( {sin}^{- 1} ( \frac{{n}_{air} sin {θ}_{2}}{{n}_{2}} ) )} \qquad [ Equation 16 ]$$

Then, the calculator 230 substitutes Equation 15 into the propagation distance (l₁) of Equation 13 and Equation 16 into the propagation distance (l₂) of Equation 14 to calculate the index of refraction of the second layer. Assuming that the index of refraction (n₁) of the second layer 20 for the terahertz wave (I₁) and the index of refraction (n₂) of the second layer 20 for the terahertz wave (I₂) have the same values, and that the thickness (d₁) of the second layer 20 for the terahertz wave (I₁) and the thickness (d₂) of the second layer 20 for the terahertz wave (I₂) have the same value, the index of refraction of the second layer may be defined by Equation 17.

$${n}_{s} = \frac{\sqrt{Δ {t}_{2}^{2} {n}_{air}^{2} {sin}^{2} ( {θ}_{2} ) - Δ {t}_{1}^{2} {n}_{air}^{2} {sin}^{2} ( {θ}_{1} )}}{\sqrt{Δ {t}_{2}^{2} - Δ {t}_{1}^{2}}} \qquad [ Equation 17 ]$$

$${d}_{1} = \frac{C Δ {t}_{1}}{2 {n}_{2}} \times cos ( {sin}^{- 1} ( \frac{{n}_{air} sin {θ}_{1}}{{n}_{2}} ) )$$

$${d}_{2} = \frac{C Δ {t}_{2}}{2 {n}_{2}} \times cos ( {sin}^{- 1} ( \frac{{n}_{air} sin {θ}_{2}}{{n}_{2}} ) )$$

According to this embodiment, the calculator 230 may calculate the index of refraction (nₛ) of the second layer 20 through Equation 17.

As confirmed in Equation 17, the index of refraction (nₛ) of the second layer 20 may be calculated from the time parameters, that is, the detection time difference (Δt₁) between the detection time of the first terahertz wave (R_{1S}) and the detection time of the second terahertz wave (R_{1T}) and the detection time difference (Δt₂) between the detection time of the first terahertz wave (R_{2S}) and the detection time of the second terahertz wave (R_{2T}), the incidence angle (θ₁) of the terahertz wave (I₁), and the incidence angle (θ₂) of the terahertz wave (I₂).

Here, according to this embodiment, the calculator 230 may also calculate the thickness (d) of the second layer 20 by applying the index of refraction (nₛ) of the second layer 20 calculated through Equation 17.

### Example 1

Referring to FIG. 15, in Example 1, a specimen including a first layer and a second layer stacked on the first layer was prepared and terahertz waves were emitted towards the second layer at an incidence angle (θ₁) of 30° with respect to the second layer, followed by measuring a detection time difference (Δt₁) between a detection time of a terahertz wave (R_{1S}) reflected from a surface of the second layer and a detection time of a terahertz wave (R_{1T}) reflected from an interface between the first layer and the second layer. At the same time, after emitting the terahertz waves at an incidence angle (θ₂) of 60°, a detection time difference (Δt₂) between a detection time of a terahertz wave (R_{2S}) reflected from the surface of the second layer and a detection time of a terahertz wave (R_{2T}) reflected from the interface between the first layer and the second layer was measured.

The detection time difference (Δt₁) was measured to be 5.26419 ps and the detection time difference (Δt₂) was measured to be 5.7061 ps.

As a result of substitution of these measurements into Equation 17, the index of refraction (nₛ) of the second layer was calculated to be 1.89951 and the thickness (d) of the second layer was calculated to be 400.764 μm. Here, the index of refraction (nₐᵢᵣ) of air is 1 and the speed of light (C) is 299,792,458 m/s.

Since the actual thickness of the second layer was 391.2 μm, the calculated value, i.e., the measured value, had an error rate of about 2.44%.

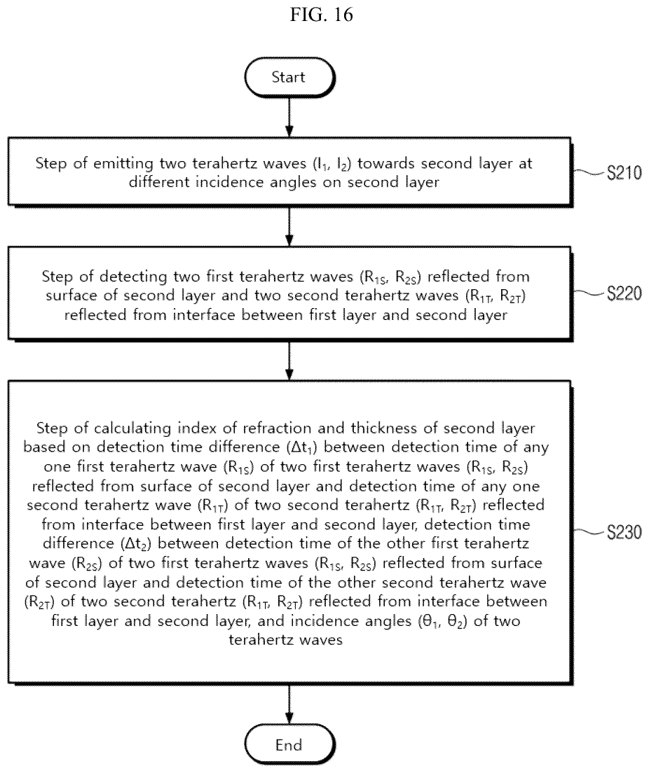

Next, a thickness measurement method according to another embodiment of the present invention will be described with reference to FIG. 16.

FIG. 16 is a flowchart illustrating a thickness measurement method according to another embodiment of the present invention.

Referring to FIG. 16, the thickness measurement method according to this embodiment may include Steps S210 to S230.

### Step S210

In Step S210, two terahertz waves (I₁, I₂) may be emitted towards the second layer 20 at different incidence angles on the second layer 20. In Step S210, the incidence angles (01, 02) of the two terahertz waves (I₁, I₂) with respect to the second layer 20 may be set within 0° to 90°.

### Step S220

In Step S220, two first terahertz waves (R_{1S}, R_{2S}) reflected from the surface of the second layer 20 may be detected with reference to reflected locations of the two terahertz waves (I₁, I₂).

Further, in Step S220, two second terahertz waves (R_{1T}, R_{2T}) reflected from the interface between the first layer 10 and the second layer 20 may be detected.

### Step S230

In Step S230, an index of refraction of the second layer 20 may be calculated based on a detection time difference (Δt₁) between a detection time of any one first terahertz wave (R_{1S}) of the two first terahertz waves (R_{1S}, R_{2S}) reflected from the surface of the second layer 20 and a detection time of any one second terahertz wave (R_{1T}) of the two second terahertz waves (R_{1T}, R_{2T}) reflected from the interface between the first layer 20 and the second layer 20, a detection time difference (Δt₂) between a detection time of the other first terahertz wave (R_{2S}) of the two first terahertz waves (R_{1S}, R_{2S}) reflected from the surface of the second layer 20 and a detection time of the other second terahertz wave (R_{2T}) of the two second terahertz waves (R_{1T}, R_{2T}) reflected from the interface between the first layer 10 and the second layer 20, and the incidence angles (θ₁, θ₂) of the two terahertz waves (I₁, I₂).

Here, in determining the detection times of the first terahertz waves (R_{1S}, R_{2S}) and the second terahertz waves (R_{1T}, R_{2T}) in Step230, the calculator 230 may determine the detection times based on maximum values thereof, minimum values thereof, or intermediate values between the maximum values and the minimum values

According to this embodiment, in Step S230, the index of refraction (nₛ) of the second layer 20 may be calculated by substituting the detection time difference (Δt₁) between the detection time of the first terahertz wave (R_{1S}) and the detection time of the second terahertz wave (R_{1T}), the detection time difference (Δt₂) between the detection time of the first terahertz wave (R_{2S}) and the detection time of the second terahertz wave (R_{2T}), the incidence angle (θ₁) of the emitted terahertz wave (I₁), and the incidence angle (θ₂) of the emitted terahertz wave (I₂) into Equation 17, and the thickness (d) of the second layer 20 may be calculated based on the calculated index of refraction (nₛ) of the second layer 20.

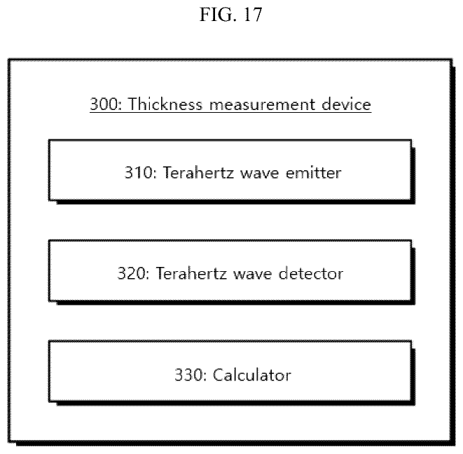

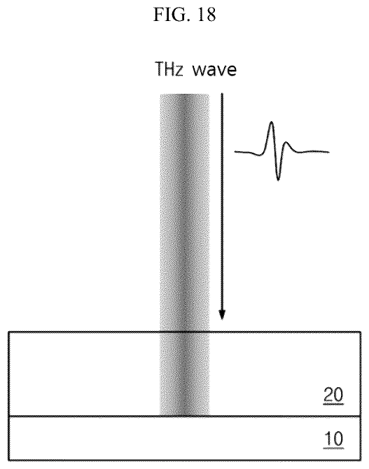

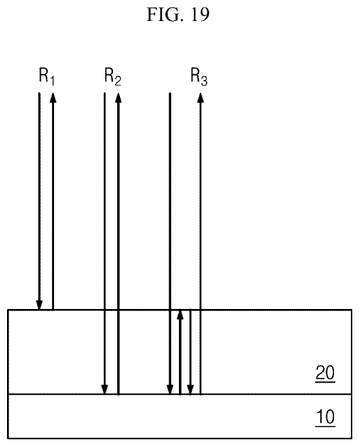

Hereinafter, a thickness measurement device according to a further embodiment of the present invention will be described with reference to FIG. 17 to FIG. 22.

Referring to FIG. 17 to FIG. 19, the thickness measurement device 300 according to this embodiment measures the thickness of a second layer 20, as a thickness measurement object, in a specimen including a first layer 10 and the second layer 20 stacked on the first layer 10. Here, the thickness measurement device 300 according to this embodiment measures the thickness of the second layer 20 in a reflection mode of terahertz waves (THz waves), whereby the thickness of the second layer 20 can be measured even when the first layer 10 is composed of metal.

The thickness measurement device 300 according to this embodiment may include a terahertz wave emitter 310, a terahertz wave detector 320, and a calculator 330.

The terahertz wave emitter 310 may emit terahertz waves toward the second layer 20. Here, the terahertz wave emitter 310 may emit terahertz waves in a direction perpendicular to a surface of the specimen, more specifically to the second layer 20.

The terahertz wave detector 320 may detect a first terahertz wave R₁ perpendicularly reflected from the surface of the second layer 20 with reference to a reflected location of the terahertz wave. In addition, the terahertz wave detector 320 may detect a second terahertz wave R₂ perpendicularly reflected from the interface between the first layer 10 and the second layer 20. Further, the terahertz wave detector 320 may detect a third terahertz wave R₃ reflected through internal reflection within the second layer 20.

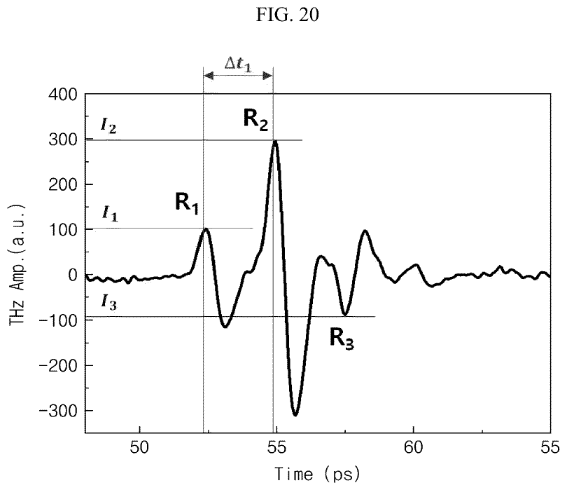

Referring to FIG. 20, the calculator 330 may calculate the index of refraction of the second layer 20 based on a detection time difference (Δt₁) between a detection time of the first terahertz wave (R₁), which is perpendicularly reflected from the surface of the second layer 20 after being perpendicularly delivered thereto through the terahertz wave emitter 310, and a detection time of the second terahertz wave (R₂), which is perpendicularly reflected from the exposed surface of the first layer 10 after being perpendicularly delivered thereto through the terahertz wave emitter 310, and signal intensities (I₁, I₂, I₃) of the first terahertz wave (R₁), the second terahertz wave (R₂), and the third terahertz wave (R₃).

According to this embodiment, in determining the detection times of the first terahertz wave R₁, the second terahertz wave R₂, and the third terahertz wave R₃, the calculator 330 may determine the detection times based on maximum values of the first terahertz wave R₁, the second terahertz wave R₂, and the third terahertz wave R₃.

Alternatively, the calculator 130 may determine the detection times thereof based on minimum values of the first terahertz wave (R₁), the second terahertz wave (R₂), and the third terahertz wave (R₃), or based on intermediate values between the maximum values and the minimum values.

In addition, according to this embodiment, in determining the signal intensities of the first terahertz wave (R₁), the second terahertz wave (R₂), and the third terahertz wave (R₃), the calculator 330 may determine the signal intensities based on the maximum values of the first terahertz wave (R₁), the second terahertz wave (R₂), and the third terahertz wave (R₃), the minimum values thereof, or the intermediate values between the maximum values and the minimum values.

In addition, the calculator 330 may calculate the thickness of the second layer 20 based on the calculated index of refraction of the second layer 20.

To this end, the calculator 330 may define a relationship between reflectance R and transmittance T according to Equation 18.

$$R + T = 1 \qquad [ Equation 18 ]$$

In addition, the calculator 330 may define the signal intensities (I₁, I₂, I₃) corresponding to the first terahertz wave (R₁), the second terahertz wave (R₂), and the third terahertz wave (R₃) based on the reflectance (R), the transmittance (T), the absorption rate (A), and fundamental signal intensity (I_{ref}) represented by Equations 19 to 21.

$${( \frac{{I}_{1}}{{I}_{ref}} )}^{2} = R \qquad [ Equation 19 ]$$

$${( \frac{{I}_{2}}{{I}_{ref}} )}^{2} = {T}^{2} \times A \qquad [ Equation 20 ]$$

$${( \frac{{I}_{3}}{{I}_{ref}} )}^{2} = {T}^{2} \times R \times {A}^{2} \qquad [ Equation 21 ]$$

Here, the calculator 330 may transform Equation 18 into the following Equation 22.

$$R = 1 - T \qquad [ Equation 22 ]$$

Further, the calculator 330 may transform Equation 19 into the following Equation 23.

$${I}_{ref}^{2} = {\frac{( {I}_{1} )}{R}}^{2} = \frac{{( {I}_{1} )}^{2}}{1 - T} \qquad [ Equation 23 ]$$

In addition, the calculator 330 may transform Equation 20 into the following Equation 24.

$$A = {( \frac{{I}_{2}}{{I}_{ref} \times T} )}^{2} = {( \frac{{I}_{2}}{{I}_{1}} \times \frac{1 - T}{T} )}^{2} \qquad [ Equation 24 ]$$

Next, the calculator 330 may substitute Equation 22 or Equation 23 into Equation 21, which may be transformed into the following Equation 25.

$$[ {( {I}_{1} )}^{2} \times {( {I}_{3} )}^{2} - {( {I}_{2} )}^{4} ] \cdot {T}^{2} + 2 {( {I}_{2} )}^{4} \cdot T - {( {I}_{2} )}^{4} = 0 \qquad [ Equation 25 ]$$

Next, the calculator 330 may solve Equation 25 to derive Equation 26 for the transmittance (T), Equation 27 for the reflectance (R), Equation 28 for the absorption rate (A), and Equation 29 for the fundamental signal intensity (I_{ref}).

$$[ Equation 26 ]$$

$$T = \frac{- {( {I}_{2} )}^{4} \pm \sqrt{{( {I}_{1} )}^{2} \times {( {I}_{3} )}^{2} \times {( {I}_{2} )}^{4}}}{{( {I}_{1} )}^{2} \times {( {I}_{3} )}^{2} - {( {I}_{2} )}^{4}} = \frac{{( {I}_{2} )}^{2}}{{I}_{1} \times {I}_{3} + {( {I}_{2} )}^{2}} ( ∵ 0 \leq T \leq 1 )$$

$$R = \frac{{I}_{1} \times {I}_{3}}{{I}_{1} \times {I}_{3} + {( {I}_{2} )}^{2}} \qquad [ Equation 27 ]$$

$$A = {( \frac{{I}_{3}}{{I}_{2}} )}^{2} \qquad [ Equation 28 ]$$

$${I}_{ref}^{2} = \frac{{I}_{1} ( {I}_{1} \times {I}_{3} + {( {I}_{2} )}^{2} )}{{I}_{3}} \qquad [ Equation 29 ]$$

Here, the calculator 330 may define a relationship between the reflectance (R) of the second layer 20, the index of refraction (nₛ) of the second layer 20, and the index of refraction (nₐᵢᵣ) of air according to the following Equation 30.

$$R = \frac{{( {n}_{s} - {n}_{air} )}^{2}}{{( {n}_{s} + {n}_{air} )}^{2}} \qquad [ Equation 30 ]$$

In addition, the calculator 330 may define the thickness (d) of the second layer 20 according to the following Equation 31 based on the detection time difference (Δt₁) between the detection time of the first terahertz wave (R₁) and the detection time of the second terahertz wave (R₂) and the index of refraction (nₛ).

$$d = \frac{C Δ {t}_{1}}{2 {n}_{s}} \qquad [ Equation 31 ]$$

where C is the speed of light.

Next, the calculator 330 may substitute the reflectance (R) of Equation 27 into 30 to derive the following Equation 32 for the index of refraction (nₛ).

$${n}_{s} = \frac{1 + \sqrt{R}}{1 - \sqrt{R}} \times {n}_{air} = \frac{1 + \sqrt{\frac{{I}_{1} \times {I}_{3}}{{I}_{1} \times {I}_{3} + {( {I}_{2} )}^{2}}}}{1 - \sqrt{\frac{{I}_{1} \times {I}_{3}}{{I}_{1} \times {I}_{3} + {( {I}_{2} )}^{2}}}} \times {n}_{air} \qquad [ Equation 32 ]$$

According to this embodiment, the calculator 330 may calculate the index of refraction (nₛ) of the second layer 20 through Equation 32.

Next, the calculator 330 may substitute the index of refraction (nₛ) of the second layer 20 calculated through Equation 27 into Equation 31 to derive the following Equation 33 for the thickness (d) of the second layer 20.

$$d = \frac{C Δ {t}_{1}}{2 {n}_{s}} = \frac{C Δ {t}_{1} ( 1 - \sqrt{\frac{{I}_{1} \times {I}_{3}}{{I}_{1} \times {I}_{3} + {( {I}_{2} )}^{2}}} )}{2 {n}_{air} ( 1 + \sqrt{\frac{{I}_{1} \times {I}_{3}}{{I}_{1} \times {I}_{3} + {( {I}_{2} )}^{2}}} )} \qquad [ Equation 33 ]$$

According to this embodiment, the calculator 330 may calculate the thickness (d) of the second layer 20 through Equation 33.

As confirmed in Equation 32 and Equation 33, the index of refraction (nₛ) of the second layer 20 and the thickness (d) of the second layer 20 may be calculated based on the signal intensities (I₁, I₂, I₃) corresponding to the first terahertz wave (R₁), the second terahertz wave (R₂), and the third terahertz wave (R₃), and the detection time difference (Δt₁) between the detection time of the first terahertz wave (R₁) perpendicularly reflected from the surface of the second layer 20 after being perpendicularly delivered thereto through the terahertz wave emitter 310 and the detection time of the second terahertz wave (R₂) perpendicularly reflected from the interface between the first layer 10 and the second layer 20 after being perpendicularly delivered thereto through the terahertz wave emitter 310.

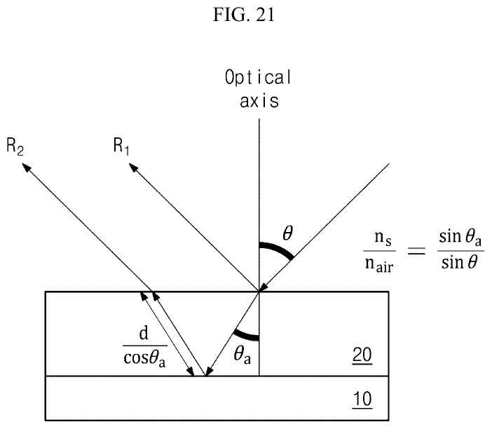

According to this embodiment, as shown in FIG. 21, the terahertz waves may be detected by the terahertz wave detector 120 after being emitted towards the second layer 20 at an incidence angle θ of greater than 0° and less than 90° through the terahertz wave emitter 310 and then reflected from the surface of the second layer 20 and the interface between the first layer 10 and the second layer 20.

Accordingly, the calculator 130 may apply the incidence angle θ to the existing equations.

In other words, according to this embodiment, the calculator 330 may define the reflectance R of the second layer 20 according to Equation 34 based on the incidence angle θ of the terahertz wave.

$$R = [ \frac{{( {n}_{s} cos θ - {n}_{air} cos {θ}_{a} )}^{2}}{{( {n}_{s} cos θ + {n}_{air} cos {θ}_{a} )}^{2}} + \frac{{( {n}_{s} cos {θ}_{a} - {n}_{air} cos θ )}^{2}}{{( {n}_{s} cos {θ}_{a} + {n}_{air} cos θ )}^{2}} ] / 2 \qquad [ Equation 34 ]$$

According to this embodiment, the calculator 330 may calculate the index of refraction (nₛ) of the second layer 20 through Equation 34 when the terahertz waves are not perpendicularly emitted towards the specimen, that is, when the terahertz waves are emitted towards the specimen at an incidence angle (θ) of greater than 0° and less than 90°.

Further, the calculator 330 may apply the incidence angle θ of the terahertz wave to Equation 31 to convert Equation 31 into the following Equation 35.

$$\frac{d}{cos {θ}_{a}} = \frac{C Δ {t}_{1}}{2 {n}_{s}} \qquad [ Equation 35 ]$$

Here, θα may be defined according to the following Equation 36.

$${θ}_{a} = {sin}^{- 1} ( sin θ \cdot \frac{{n}_{air}}{{n}_{s}} ) \qquad [ Equation 36 ]$$

The calculator 330 may substitute Equation 36 into Equation 35 to derive the following Equation 37 for the thickness (d) of the second layer 20.

$$d = \frac{C Δ {t}_{1}}{2 {n}_{s}} \cdot cos [ {sin}^{- 1} ( sin θ \cdot \frac{{n}_{air}}{{n}_{s}} ) ] \qquad [ Equation 37 ]$$

According to this embodiment, the calculator 330 may calculate the thickness (d) of the second layer 20 through Equation 33 when the terahertz waves are perpendicularly emitted towards the specimen, and may calculate the thickness (d) of the second layer 20 through Equation 37 when the terahertz waves are not perpendicularly emitted towards the specimen, that is, when the terahertz waves are emitted towards the specimen at an incidence angle θ greater than 0° and less than 90°.

### Example 2

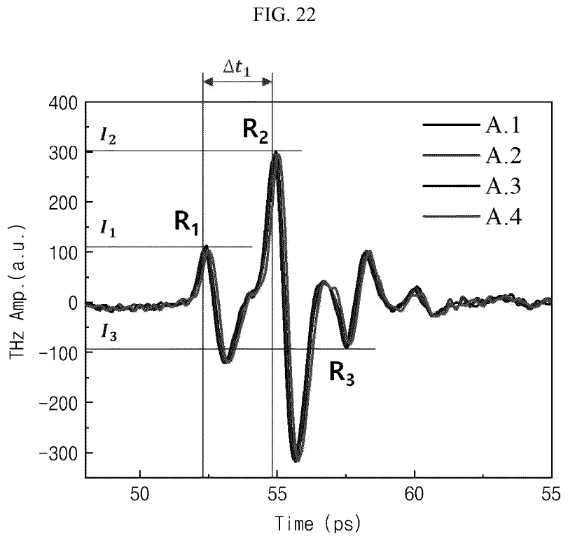

Referring to FIG. 22, in Example 2, terahertz waves were perpendicularly delivered to points A.1, A.2, A.3, and A.4 set on a silicon wafer specimen, followed by measuring a detection time difference (Δt₁) between a detection time of terahertz waves (R₁) perpendicularly reflected from a surface of an upper layer and a detection time of terahertz waves (R₂) perpendicularly reflected from an interface between the upper layer and a lower layer, and signal intensities (I₁, I₂, I₃) of the terahertz waves (R₁) perpendicularly reflected from the surface of the upper layer, the terahertz waves (R₂) perpendicularly reflected from the interface between the upper layer and the lower layer, and terahertz waves R₃ perpendicularly reflected through internal reflection within the upper layer.

Then, the detection time difference (Δt₁) and the signal intensity (I₁, I₂, I₃) were substituted into Equation 32 and Equation 33 to calculate the index of refraction (nₛ) and the thickness (d) of the upper layer at each of points A.1, A.2, A.3 and A.4. Table 1 shows the calculated index of refraction (nₛ) and the thickness (d) of the upper layer at each of the above points A.1, A.2, A.3 and A.4.

TABLE 1

| | I₁ | I₂ | I₃ | Δt₁ | | d | d_{act} | error |
|---|---|---|---|---|---|---|---|---|
| Point | (a.u.) | (a.u.) | (a.u.) | (ps) | nₛ | (μm) | (μm) | (%) |
| A.1 | 112.64 | 301.29 | 98.14 | 2.49 | 1.98 | 188.39 | 184.2 | 2.27 |
| A.2 | 102.66 | 296.20 | 102.49 | 2.45 | 1.97 | 185.99 | 181.8 | 2.30 |
| A.3 | 104.04 | 288.62 | 97.27 | 2.49 | 1.98 | 188.54 | 183 | 3.03 |
| A.4 | 102.48 | 295.83 | 102.01 | 2.48 | 1.97 | 188.75 | 183 | 3.14 |

As shown in Table 1, it can be seen from Example 2 that the measurement results of the thicknesses (d) at each point on the silicon wafer was within an error rate of 4%, as compared with measurement results of thicknesses (d_{act}) obtained using a microscope.

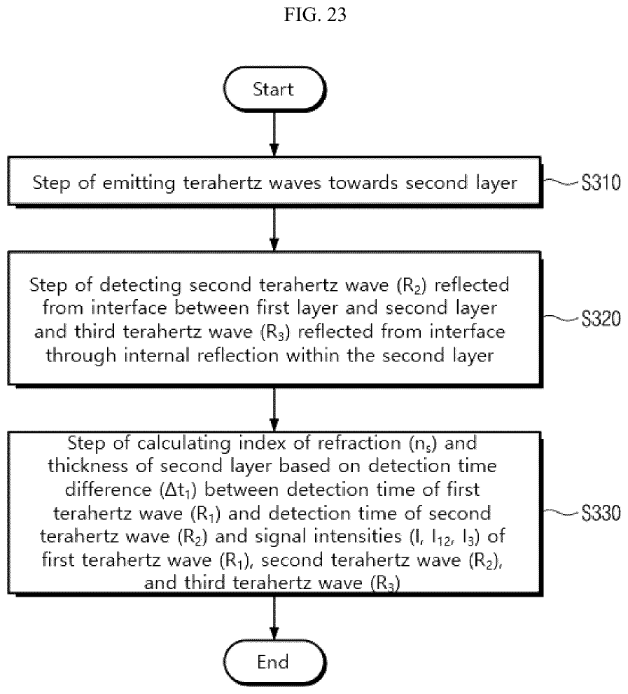

Hereinafter, a thickness measurement method according to a further embodiment of the present invention will be described with reference to FIG. 23.

FIG. 23 is a flowchart illustrating a thickness measurement method according to a further embodiment of the present invention.

Referring to FIG. 23, the thickness measurement method according to this embodiment may include Steps S310 to S330.

### Step S310

In Step S310, for a specimen including a first layer 10 and a second layer 20 stacked on the first layer 10, terahertz waves may be emitted towards an upper layer of the specimen, that is, towards a second layer 20.

### Step S320

In Step S320, a first terahertz wave (R₁) reflected from a surface of the second layer 20 after being emitted thereto may be detected.

In addition, in Step S320, a second terahertz wave (R₂) reflected from an interface between the first layer 10 and the second layer 20 after being emitted thereto may be detected. Further, in Step S320, a third terahertz wave (R₃) finally reflected from the interface through internal reflection within the second layer 20 may be detected.

### Step S330

In Step S330, an index of refraction (nₛ) of the second layer 20 may be calculated based on a detection time difference (Δt₁) between a detection time of the first terahertz wave (R₁) and a detection time of the second terahertz wave (R₂) and signal intensities (I, I₁₂, I₃) of the first terahertz wave (R₁), the second terahertz wave (R₂), and the third terahertz wave (R₃).

In Step S330, the detection times may be determined based on maximum values of the first terahertz wave (R₁), the second terahertz wave (R₂), and the third terahertz wave (R₃). Alternatively, in Step S330, the detection times may be determined based on minimum values of the first terahertz wave (R₁), the second terahertz wave (R₂), and the third terahertz wave (R₃), or based on intermediate values between the maximum values and the minimum values.

Here, in Step S330, the signal intensities may be determined based on the maximum values of the first terahertz wave (R₁), the second terahertz wave (R₂), and the third terahertz wave (R₃), the minimum values thereof, or the intermediate values between the maximum values and the minimum values.

Then, in Step S330, the thickness (d) of the second layer 20 may be calculated based on the calculated index of refraction (nₛ) of the second layer 20.

According to this embodiment, in Step S330, when the terahertz waves are perpendicularly emitted towards the specimen, more specifically towards the surface of the second layer 20, the index of refraction (nₛ) of the second layer 20 may be calculated through Equation 32, and the calculated index of refraction (nₛ) of the second layer 20 may be applied to Equation 33 to calculate the thickness (d) of the second layer 20.

Further, in Step S330, where the terahertz waves are emitted at an incidence angle (θ) of greater than 0° and less than 90° toward the specimen, more specifically toward the surface of the second layer 20, the index of refraction (nₛ) of the second layer 20 may be calculated through Equation 34, and the calculated index of refraction (nₛ) of the second layer 20 may be applied to Equation 37 to calculate the thickness (d) of the second layer 20.

Accordingly, the embodiments of the present invention may provide the thickness measurement devices 100, 200, 300 and the thickness measurement methods that can provide reliable thickness information about a second layer 20, which is a thickness measurement object, in a reflection mode of terahertz waves.

Although some embodiments have been described herein with reference to the accompanying drawings, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

1. A thickness measurement device for measuring a thickness of a second layer in a specimen including a first layer and the second layer stacked on the first layer so as to expose an edge of the first layer upwardly, the thickness measurement device comprising:
a terahertz wave emitter emitting terahertz waves toward an edge of the second layer such that the first layer and the second layer are directly irradiated with the terahertz waves at the same time by single irradiation;
a terahertz wave detector detecting, with reference to a reflected location of the terahertz waves, a first terahertz wave (R₁) reflected from a surface of the second layer, a second terahertz wave (R₂) reflected from an exposed surface of the first layer, and a third terahertz wave (R₃) reflected from an interface between the first layer and the second layer; and
a calculator calculating an index of refraction of the second layer based on a detection time difference (Δt₁) between a detection time of the first terahertz wave (R₁) and a detection time of the second terahertz wave (R₂) and a detection time difference (Δt₂) between the detection time of the first terahertz wave (R₁) and a detection time of the third terahertz wave (R₃), and calculating the thickness of the second layer based on the calculated index of refraction of the second layer.

2. The thickness measurement apparatus according to claim 1, wherein the calculator calculates the index of refraction (nₛ) of the second layer through Equation 6.
$${n}_{s} = {n}_{air} \frac{Δ {t}_{2}}{Δ {t}_{1}} \qquad [ Equation 6 ]$$
where nₐᵢᵣ is an index of refraction of air.

3. The thickness measurement apparatus according to claim 2, wherein the detection time difference (Δt₁) between the detection time of the first terahertz wave (R₁) and the detection time of the second terahertz wave (R₂) is defined by Equation 1, and the detection time difference (Δt₂) between the detection time of the first terahertz wave (R₁) and the detection time of the third terahertz wave (R₃) is defined by Equation 3;
wherein Equation 1 is transformed into Equation 2, Equation 3 is transformed into Equation 4, Equation 2 and Equation 3 are transformed into Equation 5, and Equation 5 is transformed into Equation 6; and
wherein the calculator calculates the thickness of the second layer through Equation 2 or Equation 4.
$$Δ {t}_{1} = \frac{2 {d}_{1} {n}_{air}}{C} \qquad [ Equation 1 ]$$
$${d}_{1} = \frac{C Δ {t}_{1}}{2 {n}_{air}} \qquad [ Equation 2 ]$$
$$Δ {t}_{2} = \frac{2 {d}_{2} {n}_{s}}{C} \qquad [ Equation 3 ]$$
$${d}_{2} = \frac{C Δ {t}_{2}}{2 {n}_{s}} \qquad [ Equation 4 ]$$
$$Δ {t}_{2} = \frac{2 ( \frac{C Δ {t}_{1}}{2 {n}_{air}} ) {n}_{s}}{C} = Δ {t}_{1} \frac{{n}_{s}}{{n}_{air}} \qquad [ Equation 5 ]$$
where C is the speed of light, and d₁ and d₂ are the thicknesses of the second layer, respectively.

4. The thickness measurement apparatus according to claim 3, wherein the terahertz wave detector detects the terahertz waves reflected from each of M (positive integer greater than or equal to 1)×N (positive integer greater than or equal to 1) points set on the surface of the second layer and the calculator calculates the thickness of the second layer at each point through Equation 7.
$${d}_{mn} = \frac{C Δ {t}_{mn}}{2 {n}_{s}} \qquad [ Equation 7 ]$$

5. The thickness measurement apparatus according to claim 3, wherein, when the terahertz wave emitter emits the terahertz waves at an incidence angle (θ) of greater than 0° and less than 90° toward the edge of the second layer, the calculator calculates the thickness of the second layer through Equation 8 converted from Equation 1, Equation 9 converted from Equation 2, Equation 10 converted from Equation 3, Equation 11 from Equation 4, and Equation 12 converted from Equation 5.
$$Δ {t}_{1} = \frac{2 ( \frac{d}{cos θ} ) {n}_{air}}{C} \qquad [ Equation 8 ]$$
$$d = \frac{C Δ {t}_{1}}{2 {n}_{air}} \cdot cos θ \qquad [ Equation 9 ]$$
$$Δ {t}_{2} = \frac{2 ( \frac{d}{cos [ {sin}^{- 1} ( sin θ \frac{{n}_{air}}{{n}_{s}} ) ]} ) {n}_{s}}{C} \qquad [ Equation 10 ]$$
$$d = \frac{C Δ {t}_{2}}{2 {n}_{s}} \cdot cos [ {sin}^{- 1} ( sin θ \cdot \frac{{n}_{air}}{{n}_{s}} ) ] \qquad [ Equation 11 ]$$
$$Δ {t}_{2} - \frac{2 ( \frac{\frac{C Δ {t}_{1}}{2 {n}_{air}} \cdot cos θ}{cos [ {sin}^{- 1} ( sin θ \frac{{n}_{air}}{{n}_{s}} ) ]} ) {n}_{s}}{C} = \frac{Δ {t}_{1} \cdot cos θ}{cos [ {sin}^{- 1} ( sin θ \frac{{n}_{air}}{{n}_{s}} ) ]} \frac{{n}_{s}}{{n}_{air}} \qquad [ Equation 12 ]$$

6. A thickness measurement device for measuring a thickness of a second layer in a specimen including a first layer and the second layer stacked on the first layer,
a terahertz wave emitter emitting two terahertz waves (I₁, I₂) towards the second layer at different incidence angles on the second layer;
a terahertz wave detector detecting, with reference to reflected locations of the two terahertz waves (I₁, I₂), two first terahertz waves (R_{1S}, R_{2S}) reflected from a surface of the second layer and two second terahertz waves (R_{1T}, R_{2T}) reflected from an interface between the first layer and the second layer; and
a calculator calculating an index of refraction of the second layer based on a detection time difference (Δt₁) between a detection time of any one first terahertz wave (R_{1S}) of the two first terahertz waves (R_{1S}, R_{2S}) reflected from the surface of the second layer and a detection time of any one second terahertz wave (R_{1T}) of the two second terahertz waves (R_{1T}, R_{2T}) reflected from the interface between the first layer and the second layer, a detection time difference (Δt₂) between a detection time of the other first terahertz wave (R_{2S}) of the two first terahertz waves (R_{1S}, R_{2S}) reflected from the surface of the second layer and a detection time of the other second terahertz wave (R_{2T}) of the two second terahertz waves (R_{1T}, R_{2T}) reflected from the interface between the first layer and the second layer, and the incidence angles (θ₁, θ₂) of the two terahertz waves (I₁, I₂), and calculating the thickness of the second layer based on the calculated index of refraction of the second layer.

7. The thickness measurement apparatus according to claim 6, wherein the calculator calculates the index of refraction (nₛ) of the second layer through Equation 17.
$$\begin{matrix}{n}_{s} = \frac{\sqrt{Δ {t}_{2}^{2} {n}_{air}^{2} {sin}^{2} ( {θ}_{2} ) - Δ {t}_{1}^{2} {n}_{air}^{2} {sin}^{2} ( {θ}_{1} )}}{\sqrt{Δ {t}_{2}^{2} - Δ {t}_{1}^{2}}} \\ {d}_{1} = \frac{C Δ {t}_{1}}{2 {n}_{s}} \times cos ( {sin}^{- 1} ( \frac{{n}_{air} sin {θ}_{1}}{{n}_{s}} ) ) \\ {d}_{2} = \frac{C Δ {t}_{2}}{2 {n}_{s}} \times cos ( {sin}^{- 1} ( \frac{{n}_{air} sin {θ}_{2}}{{n}_{s}} ) )\end{matrix} \qquad [ Equation 17 ]$$
where nₐᵢᵣ is an index of refraction of air, C is the speed of light, θ₁ is an incidence angle of one terahertz wave (I₁) of the two terahertz waves (I₁, I₂) on the second layer, θ₂ is an incidence angle of the other terahertz wave (I₂) of the two terahertz waves (I₁, I₂) on the second layer, and d₁ and d₂ are the thicknesses of the second layer, respectively.

8. The thickness measurement apparatus according to claim 7, wherein Equation 17 is derived through Equation 13 to Equation 16.
$${n}_{1} = \frac{C Δ {t}_{1}}{2 {l}_{1}} \qquad [ Equation 13 ]$$
$${n}_{2} = \frac{C Δ {t}_{2}}{2 {l}_{2}} \qquad [ Equation 14 ]$$
$${l}_{1} = \frac{{d}_{1}}{cos ( {sin}^{- 1} ( \frac{{n}_{air} sin {θ}_{1}}{{n}_{1}} ) )} \qquad [ Equation 15 ]$$
$${l}_{2} = \frac{{d}_{2}}{cos ( {sin}^{- 1} ( \frac{{n}_{air} sin {θ}_{2}}{{n}_{2}} ) )} \qquad [ Equation 16 ]$$
where l₁ is a distance by which one terahertz wave (I₁) of the two terahertz waves (I₁, I₂) propagates into the second layer, l₂ is a distance by which the other terahertz wave (I₂) of the two terahertz waves (I₁, I₂) propagates into the second layer, and n₁ and n₂ are the indexes of refraction of the second layer, respectively.

9. A thickness measurement device for measuring a thickness of a second layer in a specimen including a first layer and the second layer stacked on the first layer, the thickness measurement device comprising:
a terahertz wave emitter emitting terahertz waves toward the second layer;
a terahertz wave detector detecting, with reference to a reflected location of the terahertz waves, a first terahertz wave (R₁) reflected from a surface of the second layer, a second terahertz wave (R₂) reflected from an interface between the first layer and the second layer, and a third terahertz wave (R₃) reflected from the interface through internal reflection within the second layer; and
a calculator calculating an index of refraction of the second layer based on a detection time difference (Δt₁) between a detection time of the first terahertz wave (R₁) and a detection time of the second terahertz wave (R₂), and signal intensities (I₁, I₂, I₃) of the first terahertz wave (R₁), the second terahertz wave (R₂), and the third terahertz wave (R₃), and calculating the thickness of the second layer based on the calculated index of refraction of the second layer.

10. The thickness measurement apparatus according to claim 9, wherein the calculator calculates the index of refraction (nₛ) of the second layer through Equation 32 and the thickness (d) of the second layer through Equation 33.
$${n}_{s} = \frac{1 + \sqrt{R}}{1 - \sqrt{R}} \times {n}_{air} = \frac{1 + \sqrt{\frac{{I}_{1} \times {I}_{3}}{{I}_{1} \times {I}_{3} + {( {I}_{2} )}^{2}}}}{1 - \sqrt{\frac{{I}_{1} \times {I}_{3}}{{I}_{1} \times {I}_{3} + {( {I}_{2} )}^{2}}}} \times {n}_{air} \qquad [ Equation 32 ]$$
$$d = \frac{C Δ {t}_{1}}{2 {n}_{s}} = \frac{C Δ {t}_{1} ( 1 - \sqrt{\frac{{I}_{1} \times {I}_{3}}{{I}_{1} \times {I}_{3} + {( {I}_{2} )}^{2}}} )}{2 {n}_{air} ( 1 + \sqrt{\frac{{I}_{1} \times {I}_{3}}{{I}_{1} \times {I}_{3} + {( {I}_{2} )}^{2}}} )} \qquad [ Equation 33 ]$$

11. The thickness measurement apparatus according to claim 10, wherein, when the terahertz wave emitter emits the terahertz wave at an incidence angle (θ) of greater than 0° and less than 90° toward the second layer, the calculator calculates the thickness (d) of the second layer through Equation 37 converted from Equation 33.
$$d = \frac{C Δ {t}_{1}}{2 {n}_{s}} \cdot cos [ {sin}^{- 1} ( sin θ \cdot \frac{{n}_{air}}{{n}_{s}} ) ] \qquad [ Equation 37 ]$$

12. A thickness measurement method comprising: for a specimen including a first layer and a second layer stacked on the first layer so as to expose an edge of the first layer upwardly,
emitting terahertz waves towards an edge of the second layer such that the first layer and the second layer are directly irradiated with the terahertz waves at the same time by single irradiation;
detecting, with reference to a reflected location of the terahertz waves, a first terahertz wave (R₁) reflected from a surface of the second layer, a second terahertz wave (R₂) reflected from an exposed surface of the first layer, and a third terahertz wave (R₃) reflected from an interface between the first layer and the second layer; and
calculating an index of refraction of the second layer based on a detection time difference (Δt₁) between a detection time of the first terahertz wave (R₁) and a detection time of the second terahertz wave (R₂) and a detection time difference (Δt₂) between the detection time of the first terahertz wave (R₁) and a detection time of the third terahertz wave (R₃), followed by calculating a thickness of the second layer based on the calculated index of refraction of the second layer.

13. A thickness measurement method comprising: for a specimen including a first layer and a second layer stacked on the first layer,
emitting two terahertz waves (I₁, I₂) towards the second layer at different incidence angles on the second layer;
detecting, with reference to reflected locations of the two terahertz waves (I₁, I₂), two first terahertz waves (R_{1S}, R_{2S}) reflected from a surface of the second layer and two second terahertz waves (R_{1T}, R_{2T}) reflected from an interface between the first layer and the second layer; and
calculating an index of refraction of the second layer based on a detection time difference (Δt₁) between a detection time of any one first terahertz wave (R_{1S}) of the two first terahertz waves (R_{1S}, R_{2S}) reflected from the surface of the second layer and a detection time of any one second terahertz wave (R_{1T}) of the two second terahertz waves (R_{1T}, R_{2T}) reflected from the interface between the first layer and the second layer, a detection time difference (Δt₂) between a detection time of the other first terahertz wave (R_{2S}) of the two first terahertz waves (R_{1S}, R_{2S}) reflected from the surface of the second layer and a detection time of the other second terahertz wave (R_{2T}) of the two second terahertz waves (R_{1T}, R_{2T}) reflected from the interface between the first layer and the second layer, and the incidence angles (θ₁, θ₂) of the two terahertz waves (I₁, I₂), followed by calculating a thickness of the second layer based on the calculated index of refraction of the second layer.

14. A thickness measurement method comprising: for a specimen including a first layer and a second layer stacked on the first layer,
emitting terahertz waves toward the second layer;
detecting, with reference to a reflected location of the terahertz waves, a first terahertz wave (R₁) reflected from a surface of the second layer, a second terahertz wave (R₂) reflected from an interface between the first layer and the second layer, and a third terahertz wave (R₃) reflected from the interface through internal reflection within the second layer; and
calculating an index of refraction of the second layer based on a detection time difference (Δt₁) between a detection time of the first terahertz wave (R₁) and a detection time of the second terahertz wave (R₂), and signal intensities (I₁, I₂, I₃) of the first terahertz wave (R₁), the second terahertz wave (R₂), and the third terahertz wave (R₃), followed by calculating a thickness of the second layer based on the calculated index of refraction of the second layer.
